(19) United States
(12) Patent Application Publication
(10) Pub. No.: US 2010/0296062 A1
(43) Pub. Date: Nov. 25, 2010

(54) PROJECTION DISPLAY DEVICE

(76) Inventors: Ming-Kuen Lin, Taoyuan County (TW); Tsung-Hsun Wu, Taoyuan County (TW)

Correspondence Address: Muncy, Geissler, Olds & Lowe, PLLC, 4000 Legato Road, Suite 310, FAIRFAX, VA, 22033, US

(21) Appl. No.: 12/784,174

(22) Filed: May 20, 2010

(30) Foreign Application Priority Data
May 21, 2009 (TW) 098116923

(51) Int. Cl. G03B 21/28; G03B 21/00; G03B 21/14

(52) U.S. Cl. 353/31; 353/122; 353/30

(57) ABSTRACT

The invention discloses a projection display device. The projection display device includes a light module, a director, an image generator, and an image projection lens set. The light module emits a light along a first light path. The director directs the light toward a second light path. The image generator directs the light directed by the director toward a third light path, wherein a reference surface is defined to cross where the second light path crosses the image generator and to be substantially vertical to the image generator. Particularly, the light module, the director, the image generator, and the image projection lens set are substantially disposed at a side of the reference surface.

### BACKGROUND OF THE INVENTION

1. Field of the Invention

The present invention relates to a projection display device, and more particularly, to a projection display device with a largely reduced volume.

2. Description of the Prior Art

Recently, with the rapid developing of high technology, especially in the region of the microelectronic related manufacturing processes, therefore, the electronic related products have deeply penetrated into every family and industry and have become an indispensable part of our modern life.

Of course, since there are more and more requests for the human needs, the electronic apparatus must be used in more functions, and the electronic products are developed to have smaller structure and achieve the purpose of diversification effect. In various electronic products, the development and application of the projector can widely facilitate human's life. With the progress of the projector technology, since the projector product has advantages of smaller volume, lighter weight, and easy to carry, and the continuously enhanced performance and the growing sales of the laptops, multimedia presentation has become more and more popular. Therefore, the projector production which was only popular on the OA market originally will also develop on the PC market in addition to the consumer electronic market. And, the developing trend of the projector production focuses on the directions of enhancing functions of the projector, reducing the cost of the projector, and shrinking the volume of the projector.

The conventional projector includes a lamp, an optical engine, a lens, and a housing. The optical engine mainly includes a light pipe, a color wheel, a group of direction devices, and a digital micro-mirror device (DMD). The lamp is disposed in the housing and used for emitting a light. After the light emitted from the lamb passes the color wheel, at least RGB Lights are generated. The light pipe is one of the important optical devices in the projector, and the main function of the light pipe is to direct the light to be the uniform light with rectangular sections. After the RGB Lights are transmitted by the light pipe, the RGB Lights are emitted into the above-mentioned direction devices. Afterward, the RGB Lights reflected by the director are emitted into the digital micro-mirror device. Under a normal mode of the projector, after the RGB Lights are reflected by the digital micro-mirror device and pass through the lens, the projected image will be projected on a projection screen.

Please refer to FIG. 1. FIG. 1 illustrates a lateral scheme diagram of the optical devices in a conventional projection display apparatus. As shown in FIG. 1, in the conventional projection display apparatus, a light module 722, a color synthesizer 724, light uniform devices 726a and 726b, a light collector 728, and a director 730 are substantially disposed at a side of the reference surface 7320 (it is the lower side in the showing directions of this figure), but the image projection lens set 734 is substantially disposed at the other side of the reference surface 7320 (it is the upper side in the showing directions of this figure). In other words, the centers of gravity of the light module 722, the color synthesizer 724, the light uniform devices 726a and 726b, the light collector 728, the director 730, and the image generator 732 of the conventional projection display apparatus and the center of gravity of the image projection lens set 734 are disposed at different sides of the reference surface 7320. Further, the light center 7224 of the light module 722 passed by the first light path 80, the first crossing point 7240 of the color synthesizer 724 passed by the first light path 80, the second crossing points 7260a and 7260b of the light uniform devices 726a and 726b passed by the first light path 80, the third crossing point 7280 of the light collector 728 passed by the first light path 80, and the first region 7300 of the director 730 formed by the crossing of the first light path 80 and the second light path 82 are disposed at a side of the reference surface different from that of the lens center 7340 of the image projection lens set 734 passed by the third light path 84. Therefore, it can be known that the size of the conventional projection display apparatus can not be reduced in vertical direction, and therefore the purpose of reducing the entire volume of the projection display apparatus can not be achieved.

Additionally, in general, the conventional projector usually uses one selected from a tungsten halogen lamp, a metal halide lamp, an ultra-high pressure mercury lamp or a xenon lamp as its light source. The above-mentioned light sources have many common disadvantages such as over-heat, high power consumption, low lamp life, excessive volume, heavy weight, and hard to carry, so that it is hard for the size of the conventional projector to be reduced. Therefore, in recent years, the conventional LED having advantages of relatively lower power consumption, lower heating value, smaller volume, and longer life is used as the light source of the projector.

However, as far as the structure of the conventional projector is concerned, even the optical engine using the director can obtain better optical quality, but it is not good for the size reduction of the projector. In addition, limited by the optical characteristic of the conventional LED and the light emitting way toward all directions, the conventional projector using the conventional LED as the light source apparatus not only has poor image color saturation, brightness, and sharpness, but also has lower light usage efficiency due to the light emitting way toward all directions, so that the projection brightness can not be further enhanced. Therefore, in the trend of the requirements for higher resolution and image quality of consumer on the current market, how to meet the requirements of the consumers to design a smaller projector having better image quality, brighter color, and stabler light source output with high brightness is one of the important developing issues of the current industry.

In view of this, a scope of the invention is to provide a projection display apparatus. Especially, the projection display apparatus provides a new design of light path to make the optical devices in the projection display apparatus be more closely disposed in the narrow space, so that the volume of the projection display apparatus can be largely reduced within the standard of acceptable optical imaging quality. In other words, the projection display apparatus of the invention provides a very simple and effective solution for integrating, simplifying, and arranging the optical devices in the projection display apparatus. Not only the utility rate of space can be obviously increased, but also the cost of the devices used in the projection display apparatus can be reduced.

### SUMMARY OF THE INVENTION

A scope of the invention is to provide a projection display apparatus. The projection display apparatus includes a light module, a director, an image generator, and an image projection lens set. The light module is used for emitting a light along a first light path. The director is disposed on the first light path and used for directing the light toward a second light path. The image generator is disposed on the second light path and used for further directing the light directed by the director toward a third light path, wherein a reference surface is defined to cross where a center of the second light path crosses the image generator and to be substantially vertical to the image generator. Particularly, the light module, the director, and the image projection lens set are substantially disposed at a side of the reference surface.

Another scope of the invention is to provide a projection display apparatus. The projection display apparatus includes a first light module, a second light module, and a color synthesizer. The first light module can be used for emitting a first light. The second light module can be used for emitting a second light and a third light. The color synthesizer can be used for being passed through by the first light and directing the second light and the third light toward a first light path, or the color synthesizer can be used for being passed through by the second light and the third light and directing the first light toward the first light path.

Another scope of the invention is to provide a projection display apparatus. The projection display apparatus includes a first light module, a second light module, a color synthesizer, a director, an image generator, and an image projection lens set. The first light module can be used for emitting a first light. The second light module can be used for emitting a second light and a third light. The color synthesizer can be used for being passed through by the first light and directing the second light and the third light toward a first light path, or the color synthesizer can be used for being passed through by the second light and the third light and directing the first light toward the first light path. The director is disposed on the first light path and can be used for directing the first light, the second light, and the third light toward a second light path. The image generator is disposed on the second light path and can be used for further directing the first light, the second light, and the third light toward a third light path, wherein a reference surface is defined to cross where a center of the second light path crosses the image generator and to be substantially vertical to the image generator. The image projection lens set is disposed on the third light path. Particularly, the first light module, the second light module, the color synthesizer, the director, and the image projection lens set are substantially disposed at a side of the reference surface.

Compared to the prior arts, the projection display apparatus of the invention provides a new design of light path to make the optical devices in the projection display apparatus to be more closely disposed in the narrow space, so that the volume of the projection display apparatus can be largely reduced within the standard of acceptable optical imaging quality. In other words, the projection display apparatus of the invention provides a very simple and effective solution for integrating, simplifying, and arranging the optical devices in the projection display apparatus, not only the utility rate of space can be obviously increased, but also the cost of the devices used in the projection display apparatus can be also reduced.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a lateral scheme diagram of the optical devices in a conventional projection display apparatus.

FIG. 2 illustrates an exterior view of the projection display apparatus in a preferred embodiment of the invention.

FIG. 3 illustrates a top scheme diagram of the optical devices in the projection display apparatus in a preferred embodiment of the invention.

FIG. 4A illustrates a top scheme diagram of the light module in FIG. 3 in another embodiment.

FIG. 4B illustrates a top scheme diagram of the light module shown in FIG. 3 in another embodiment.

FIG. 5 illustrates a lateral scheme diagram of the optical devices in the projection display apparatus shown in FIG. 3.

### DETAILED DESCRIPTION OF THE INVENTION

The invention provides a projection display apparatus. And, more particularly, the projection display apparatus provides a new design for the light paths in the projection display apparatus to make the optical devices in the projection display apparatus be more closely disposed in the narrow space, so that the volume of the projection display apparatus can be largely reduced within the standard of acceptable optical imaging quality. The preferred embodiments of the invention will be introduced in detail as follows to fully explain the features, spirits, advantages, and simplicity in practice.

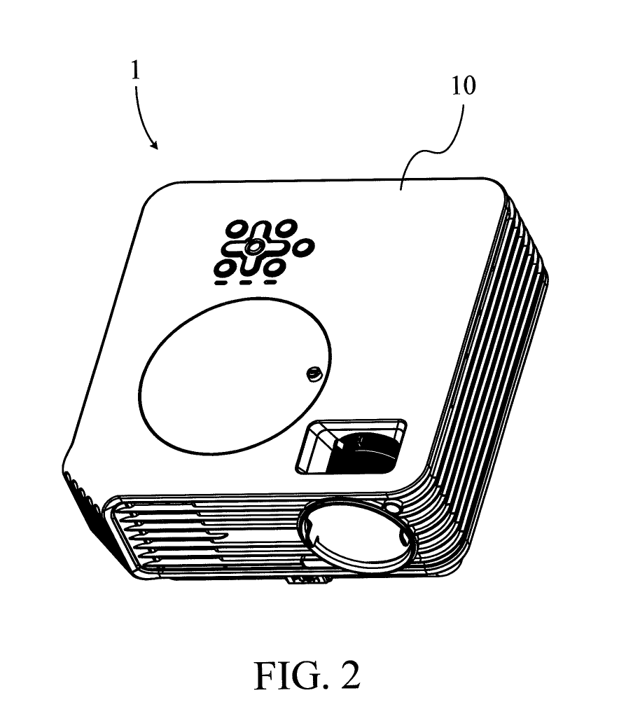

Please refer to FIG. 2. FIG. 2 illustrates an exterior view of the projection display apparatus 1 in a preferred embodiment of the invention. As shown in FIG. 2, the projection display apparatus 1 of the invention can be implemented in the ordinary projector on the market, but not limited to this. In other words, the light path design of the projection display apparatus 1 in the invention and the integration and layout of the optical devices in the projection display apparatus 1 can help the projection display apparatus 1 to be applied in the various handheld electronic apparatuses (e.g., the mobile phone) on the market. Additionally, the projection display apparatus 1 of the invention also includes a housing 10 and a power supply unit (not shown in the figures). The projection display apparatus 1 in this embodiment of the invention including the structures and functions of the various parts of the projection display apparatus 1 will be introduced in detail as follows.

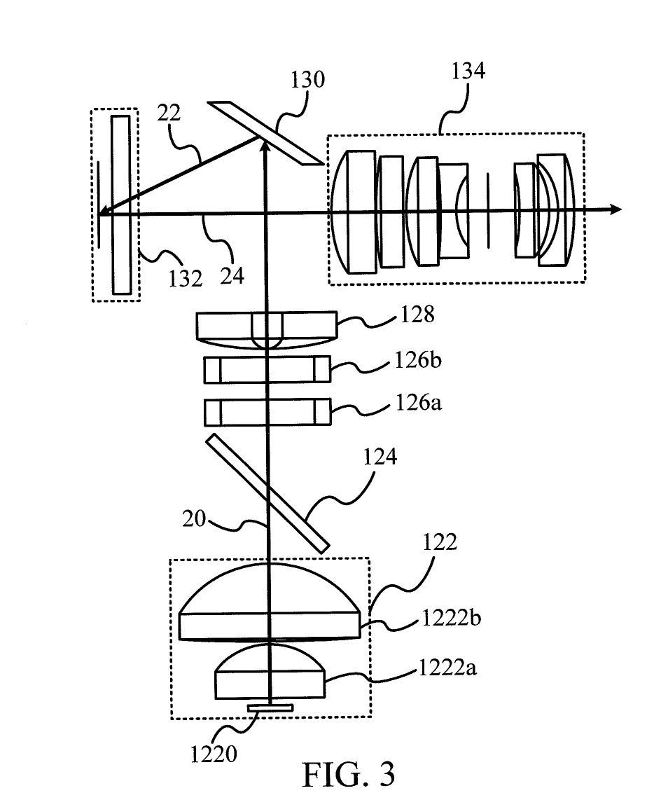

Please refer to FIG. 3. FIG. 3 illustrates a top scheme diagram of the optical devices in the projection display apparatus 1 in a preferred embodiment of the invention. As shown in FIG. 3, the projection display apparatus 1 of the invention includes a light module 122, a director 130, an image generator 132, and an image projection lens set 134. The optical devices in the projection display apparatus 1 of this embodiment of the invention will be introduced in detail as follows.

As shown in FIG. 3, the light module 122 includes a light-emitting diode (LED) 1220 and angle modulators 1222a and 1222b. The light-emitting diode 1220 can be used for emitting a light. The angle modulators 1222a and 1222b are disposed in front of the light-emitting diode 1220, and the angle modulators 1222a and 1222b can be used for adjusting the angle of the light emitted from the light-emitting diode 1220 to make the light goes along a first light path 20. It should be noticed that although there is only one light-emitting diode 1220 in this embodiment, in practical applications, the light module 122 can includes at least three light-emitting diodes emitting the lights of different colors respectively. In addition, in order to correspond to the emitting angle of the light-emitting diode 1220, although the projection display apparatus 1 of the embodiment uses two angle modulators 1222a and 1222b, in practical applications, the number of the angle modulator used in the projection display apparatus 1 can be elastically adjusted according to actual needs without any limitations.

As also shown in FIG. 3, the director 130 of the projection display apparatus 1 is disposed on the first light path 20 and can be used for directing the light emitted by the light-emitting diode 1220 toward a second light path 22. The image generator 132 of the projection display apparatus 1 is disposed on the second light path 22 and can be used for further directing the light directed by the director 130 toward a third light path 24. The image projection lens set 134 of the projection display apparatus 1 is disposed on the third light path 24. The power supply unit is disposed in the housing 10 and electrically connected to the light module 122 to provide power to the light module 122.

In addition, the projection display apparatus 1 of the invention further includes a color synthesizer 124, light uniform devices 126a and 126b, and a light collector 128, as shown in FIG. 3. The color synthesizer 124 is disposed on the first light path 20. The light uniform devices 126a and 126b are disposed on the first light path 20. The light collector 128 is also disposed on the first light path 20. And, the light emitted from the light-emitting diode 1220 of the light module 122 passes through the color synthesizer 124, light uniform devices 126a and 126b, and a light collector 128 in order, and then the light is emitted to the director 130.

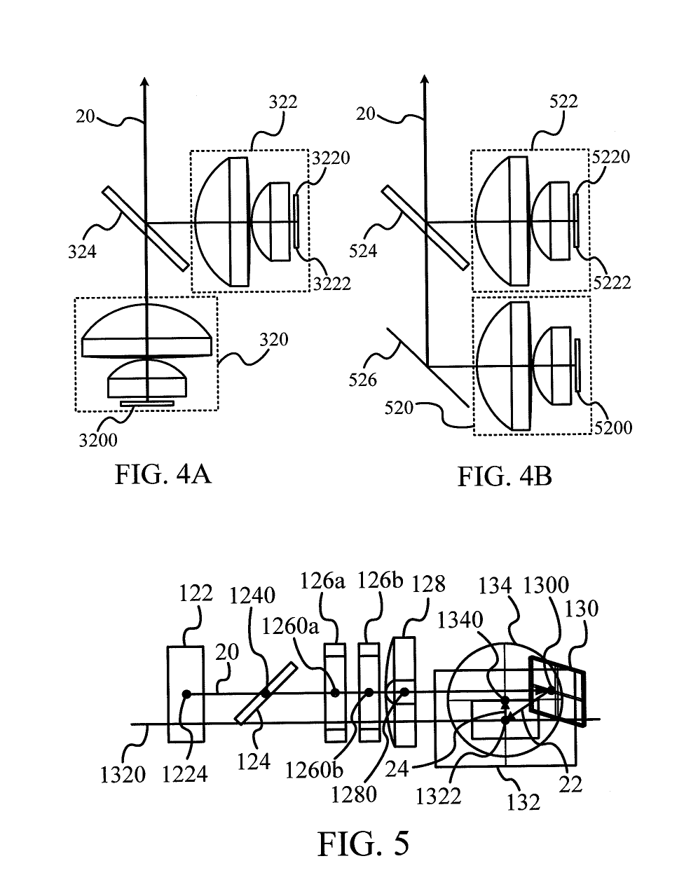

Please refer to FIG. 4A. FIG. 4A illustrates a top scheme diagram of the light module 122 shown in FIG. 3 in another embodiment. As shown in FIG. 4A, in this embodiment, the light module 122 of the projection display apparatus 1 shown in FIG. 3 of the invention can be replaced by a first light module 320 and a second light module 322. The first light module 320 can be used for emitting the first light, and the second light module 322 can be used for emitting the second light and the third light. Further, the above-mentioned first light module 320 includes a first light-emitting diode 3200 used for emitting the first light; the above-mentioned second light module 322 includes a second light-emitting diode 3220 and a third light-emitting diode 3222 used for emitting the second light and the third light, respectively. The power supply unit is disposed in the housing 10 and electrically connected to the first light module 320 and the second light module 322 for providing power to the first light module 320 and the second light module 322.

In an embodiment, the above-mentioned first light-emitting diode 3200 can be a green light light-emitting diode; the above-mentioned second light-emitting diode 3220 can be a red light light-emitting diode; and the above-mentioned third light-emitting diode 3222 can be a blue light light-emitting diode, but not limited to this. The types of the light-emitting diodes can be elastically changed according to the actual needs or design limitations.

As also shown in FIG. 4A, the color synthesizer 324 of this embodiment may be coated so that the first light can pass through the color synthesizer 324 and the color synthesizer 324 can direct the second light and the third light toward the first light path 20 to make the first light, the second light, and the third light be optically coupled. Of course, in another embodiment, the color synthesizer 324 may be coated so that it may be passed through by the second light and the third light and direct the first light toward the first light path 20, in which way the purpose of coupling the first light, the second light, and the third light can be also achieved. In other words, the position of the first light module 320 in FIG. 4A can be exchanged with that of the second light module 322.

It should be explained that the coupled first light, second light, and third light are not horizontally emitted from the image projection lens set 134 of the projection display apparatus 1. If there is a vertical displacement error between the second light-emitting diode 3220 and the third light-emitting diode 3222 disposed in the second light module 322, it is a significant probability of causing a final imaging problem. Therefore, in an embodiment, the second light-emitting diode 3220 and the third light-emitting diode 3222 in the second light module 322 can be disposed side by side. Further, if the direction of disposing the second light-emitting diode 3220 relative to the third light-emitting diode 3222 can be as parallel as possible to the first light path 20, the vertical displacement error between the second light-emitting diode 3220 and the third light-emitting diode 3222 can be reduced to further effectively solve the final imaging problem.

It should be explained that in prior arts, if three light-emitting diodes with different colors are optically coupled, each light-emitting diode is supposed to correspond to a color synthesized, and the three sets of the light-emitting diode and the color synthesizer would be disposed side by side. This will cause that the conventional projection display apparatus is longer than the projection display apparatus 1 of the invention in the size. Therefore, the purpose of reducing the entire volume of the projection display apparatus 1 can not be achieved.

Please refer to FIG. 4B. FIG. 4B illustrates a top scheme diagram of another embodiment of the light module 122 shown in FIG. 3 in another embodiment. As shown in FIG. 4B, in this embodiment, the light module 122 of the projection display apparatus 1 in FIG. 3 of the invention is replaced by a first light module 520 and a second light module 522, wherein the first light module 520 has a first light-emitting diode 5200, and the second light module 522 has a second light-emitting diode 5220 and the third light-emitting diode 5222. Since its concept is the same as that of the embodiment of FIG. 4A, it is not mentioned again here. It should be specially explained that in this embodiment, the projection display apparatus 1 of the invention can further include a mirror 526. The mirror 526 is disposed on the first light path 20 and can be used for directing the first light toward the color synthesizer 524 so that the first light passes through the color synthesizer 524 and then goes along the first light path 20, in which way the first light, the second light, and the third light can be optically coupled, as shown in FIG. 4B. Of course, in another embodiment, the mirror 526 can also direct the second light and the third light toward the color synthesizer 524 to make the second light and the third light pass through the color synthesizer 524 and go along the first light path. In that way, the purpose of coupling the first light, the second light, and the third light can be also achieved. In other words, the position of the first light module 520 in FIG. 4B can be exchanged with that of the second light module 522.

Please refer to FIG. 5. FIG. 5 illustrates a lateral scheme diagram of the projection display apparatus 1 shown in FIG. 3. As shown in FIG. 5, a reference surface 1320 can be defined to cross where a center of the second light path 22 crosses the image generator 132 and to be substantially vertical to the image generator 132 of the projection display apparatus 1 of the invention. And, the positions of the light module 122, the color synthesizer 124, the light uniform devices 126a and 126b, the light collector 128, the director 130, and the image projection lens set 134 are substantially disposed at a side of the reference surface 1320 (it is the upper side in the showing directions in this figure). In other words, if the centers of gravity of the light module 122, the color synthesizer 124, the light uniform devices 126a and 126b, the light collector 128, the director 130, and the image projection lens set 134 are disposed at the side of the reference surface 1320, then the size of the projection display apparatus 1 of the invention can be reduced in vertical direction. The entire volume of the projection display apparatus 1 accordingly is reduced.

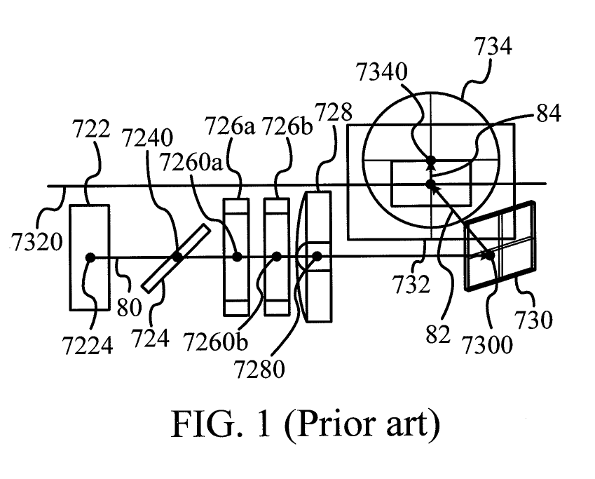

Further, the light module 122 has a light center 1224 passed by the first light path 20; the color synthesizer 124 has a first crossing point 1240 passed by the first light path 20; the light uniform devices 126a and 126b have second crossing points 1260a and 1260b passed by the first light path 20; the light collector 128 has a third crossing point 1280 passed by the first light path 20; the director 130 has a first region 1300 where the first light path 20 and the second light path 22 are crossed; the image generator 132 has a second region 1322 where the second light path 22 and the third light path 24 are crossed and where the reference surface 1320 crosses with the image generator 132; the image projection lens set 134 has a lens center 1340 passed by the third light path 24. In the same way, the light center 1224, the first crossing point 1240, the second crossing points 1260a and 1260b, the third crossing point 1280, the first region 1300, and the lens center 1340 are all disposed at the same side of the reference surface 1320. Therefore, compared to the conventional projection display apparatus in FIG. 1, the size of the projection display apparatus 1 of the invention can be reduced in the vertical direction so as to reduce the entire volume of the projection display apparatus 1.

In an embodiment, the above-mentioned image generator 132 can be a digital micromirror device (DMD), but not limited to this case. The technical staff in this region can replace the image generator 132 with a replaceable optical device.

From the preferred embodiments of the invention mentioned in detail above, it can be obvious that the projection display apparatus of the invention mainly provides a new design of the light path to make the optical devices in the projection display apparatus be more closely disposed in the narrow space, so that the volume of the projection display apparatus can be largely reduced within the standard of acceptable optical imaging quality. In other words, the projection display apparatus of the invention provides a very simple and effective solution for integrating, simplifying, and arranging the optical devices in the projection display apparatus. Not only the utility rate of space can be obviously increased, but also the cost of the devices used in the projection display apparatus can be reduced.

Although the present invention has been illustrated and described with reference to the preferred embodiment thereof, it should be understood that it is in no way limited to the details of such embodiment but is capable of numerous modifications within the scope of the appended claims.

What is claimed is:

1. A projection display apparatus, comprising:
a light module for emitting a light along a first light path;
a director, disposed on the first light path, for directing the light toward a second light path;
an image generator, disposed on the second light path, for directing the light directed by the director toward a third light path, wherein a reference surface is defined to cross where a center of the second light path crosses the image generator and to be substantially vertical to the image generator; and
an image projection lens set disposed on the third light path;
wherein the light module, the director, and the image projection lens set are substantially disposed at a side of the reference surface.

2. The projection display apparatus of claim 1, wherein the light module has a light center passed by the first light path, the director has a first region where the first light path and the second light path are crossed, the image projection lens set has a lens center passed by the third light path, and the light center, the first region, and the lens center are disposed at the side of the reference surface.

3. The projection display apparatus of claim 1, wherein the centers of gravity of the light module, the director, and the image projection lens set are disposed at the side of the reference surface.

4. The projection display apparatus of claim 1, further comprising:
a color synthesizer disposed on the first light path;
a light uniform device disposed on the first light path; and
a light collector disposed on the first light path;
wherein the light passes through the color synthesizer, the light uniform device, and the light collector in order and is then emitted to the director.

5. The projection display apparatus of claim 4, wherein the color synthesizer has a first crossing point passed by the first light path, the light uniform device has a second crossing point passed by the first light path, the light collector has a third crossing point passed by the first light path, and the first crossing point, the second crossing point, and the third crossing point are disposed at the side of the reference surface.

6. The projection display apparatus of claim 4, wherein the centers of gravity of the color synthesizer, the light uniform device, and the light collector are disposed at the side of the reference surface.

7. The projection display apparatus of claim 1, wherein the light module comprises:
a light-emitting diode (LED) for emitting the light; and
an angle modulator, adjusting the light so that the light goes along the first light path.

8. The projection display apparatus of claim 1, wherein the image generator is a digital micromirror device (DMD).

9. A projection display apparatus, comprising:
a first light module for emitting a first light;
a second light module for emitting a second light and a third light; and
a color synthesizer for being passed through by the first light and directing the second light and the third light toward a first light path, or for being passed through by the second light and the third light and directing the first light toward the first light path.

10. The projection display apparatus of claim 9, further comprising a mirror disposed on the first light path, the mirror directing the first light toward the color synthesizer so that the first light passes through the color synthesizer and goes along the first light path, or directing the second light and the third light toward the color synthesizer so that the second light and the third light pass through the color synthesizer and go along the first light path.

11. The projection display apparatus of claim 9, wherein the first light module comprises a first light-emitting diode (LED) for emitting the first light, and the second light module comprises a second light-emitting diode and a third light-emitting diode for emitting the second light and the third light, respectively.

12. The projection display apparatus of claim 11, wherein the first light-emitting diode is a green light light-emitting diode, the second light-emitting diode is a red light light-emitting diode, and the third light-emitting diode is a blue light light-emitting diode.

13. The projection display apparatus of claim 11, wherein the second light-emitting diode and the third light-emitting diode are disposed side by side.

14. The projection display apparatus of claim 11, wherein a disposing direction of the second light-emitting diode relative to the third light-emitting diode is parallel to the first light path.

15. A projection display apparatus, comprising:
a first light module for emitting a first light;
a second light module for emitting a second light and a third light;
a color synthesizer for being passed through by the first light and directing the second light and the third light toward a first light path, or being passed through by the second light and the third light and directing the first light toward the first light path;
a director, disposed on the first light path, for directing the first light, the second light, and the third light toward a second light path;
an image generator, disposed on the second light path, for further directing the first light, the second light, and the third light toward a third light path, wherein a reference surface is defined to cross where a center of the second light path crosses the image generator and to be substantially vertical to the image generator; and
an image projection lens set disposed on the third light path;
wherein the first light module, the second light module, the color synthesizer, the director, and the image projection lens set are substantially disposed at a side of the reference surface.

16. The projection display apparatus of claim 15, wherein the first light module has a first light center passed by the first light path, the second light module has a second light center passed by the first light path, the color synthesizer has a first crossing point passed by the first light path, the director has a first region where the first light path and the second light path are crossed, the image projection lens set has a lens center passed by the third light path, and the first light center, the second light center, the first crossing point, the first region, and the lens center are disposed at the side of the reference surface.

17. The projection display apparatus of claim 15, wherein the centers of gravity of the first light module, the second light module, the color synthesizer, the director, and the image projection lens set are disposed at the side of the reference surface.

18. The projection display apparatus of claim 15, further comprising:
a light uniform device disposed on the first light path; and
a light collector disposed on the first light path;
wherein the first light, the second light, and the third light pass through the color synthesizer, the light uniform device, and the light collector in order and then go to the director.

19. The projection display apparatus of claim 18, wherein the light uniform device has a second crossing point passed by the first light path, the light collector has a third crossing point passed by the first light path, and the second crossing point and the third crossing point are disposed at the side of the reference surface.

20. The projection display apparatus of claim 18, wherein the centers of gravity of the light uniform device and the light collector are disposed at the side of the reference surface.

21. The projection display apparatus of claim 15, further comprising a mirror for directing the first light toward the color synthesizer so that the first light passes through the color synthesizer and goes along the first light path, or for directing the second light and the third light toward the color synthesizer so that the second light and the third light pass through the color synthesizer and then go along the first light path.

22. The projection display apparatus of claim 15, wherein the first light module comprises a first light-emitting diode (LED) for emitting the first light, and the second light module comprises a second light-emitting diode and a third light-emitting diode for emitting the second light and the third light, respectively.

23. The projection display apparatus of claim 22, wherein the first light-emitting diode is a green light light-emitting diode, the second light-emitting diode is a red light light-emitting diode, and the third light-emitting diode is a blue light light-emitting diode.

24. The projection display apparatus of claim 22, wherein the second light-emitting diode and the third light-emitting diode are disposed side by side.

25. The projection display apparatus of claim 22, wherein a disposing direction of the second light-emitting diode relative to the third light-emitting diode is parallel to the first light path.

26. The projection display apparatus of claim 15, wherein the image generator is a digital micromirror device (DMD).
